(19) United States
(12) Patent Application Publication
(10) Pub. No.: US 2015/0052433 A1
(43) Pub. Date: Feb. 19, 2015

(54) Method of Interacting With Large Display Device and Related Interaction System

(71) Applicant: Wistron Corporation, New Taipei City (TW)

(72) Inventors: Chia-Chih Chen, New Taipei City (TW); Hung-Yang Hsu, New Taipei City (TW); Shiuan-De Chen, New Taipei City (TW); Wei-Chu Chen, New Taipei City (TW)

(73) Assignee: Wistron Corporation, New Taipei City (TW)

(21) Appl. No.: 14/097,271

(22) Filed: Dec. 5, 2013

(30) Foreign Application Priority Data
Aug. 19, 2013 (TW) 102129697

(51) Int. Cl. G06F 3/0482

(52) U.S. Cl. CPC G06F 3/0482
USPC 715/716

(57) ABSTRACT

A method of interacting with a large display device includes determining a file format of at least one file when the at least one file is opened; providing a plurality of functions on a plurality of buttons according to the file format, wherein each of the plurality of functions controls the at least one file; deploying the plurality of buttons on both sides of a main screen according to a layer layout, wherein each of the plurality of buttons includes a context or an icon corresponding to one of the plurality of functions; determining whether any of the plurality of buttons is triggered; and enabling a function of one of the plurality of buttons when the button is triggered.

### BACKGROUND OF THE INVENTION

1. Field of the Invention

The present invention relates to a method of interacting with a large display device, and more particularly, to a method of simplifying the interaction between a user and the large display device.

2. Description of the Prior Art

The screen size of modern televisions and mobile phones keeps increasing. Current devices capable of providing a larger screen are televisions, television walls or projectors. These products not only provide home theater experience, but also allow more people to watch simultaneously. In addition to the change in screen size, it is desirable to provide more intuitive methods for touch operations of these products, so that there are many techniques capable of providing interactions with the large screens, e.g. infrared and projection touch film, etc. These techniques can accurately identify the operations of the user.

It is not exactly feasible to apply the operations for personal computers or mobile devices to the large screen devices because the user has to make more efforts to move a larger distance when performing operations on the screen, and a lot of area on the screen may be blocked by the user himself. This violates the purpose of large audience capacity for the large screen and reduces utility of the interface. When the user uses these large screens, actually utilized functions may also be different from those for personal computers and mobile devices due to different purposes.

### SUMMARY OF THE INVENTION

It is therefore an objective of the present invention to provide a method of interacting with the large display device.

The present invention discloses a method of interacting with a large display device. The method includes determining a file format of at least one file when the at least one file is opened; providing a plurality of functions on a plurality of buttons according to the file format, wherein each of the plurality of functions controls the at least one file; deploying the plurality of buttons on both sides of a main screen according to a layer layout, wherein each of the plurality of buttons includes a context or an icon corresponding to one of the plurality of functions; determining whether any of the plurality of buttons is triggered; and enabling a function of one of the plurality of buttons when the button is triggered.

The present invention further discloses an interactive system. The interactive system comprises a large display device, for displaying content of a file; and an interactive application unit, for opening the file. The interactive application unit comprises a checking unit, for determining a file format of the file when the file is opened; a graphic user interface, for providing a plurality of functions according to the file format, the graphic user interface comprising a plurality of buttons, which are deployed on both sides of a main screen according to a layer layout, wherein each of the plurality of buttons includes a context or an icon corresponding to one of the plurality of functions; and an execution unit, for enabling a function of one of the plurality of buttons when the button is triggered; wherein each of the plurality of functions controls the at least one file.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a process according to an embodiment of the present invention.

FIGS. 2A, 2B and 2C are schematic diagrams of a layer layout of a plurality of buttons according to embodiments of the present invention.

FIG. 3 is a schematic diagram of an interactive system according to an embodiment of the present invention.

FIGS. 4-9 are schematic diagrams of interactive systems according to an embodiment of the present invention.

FIG. 10 is a schematic diagram of an operating process of an interactive application unit according to an embodiment of the present invention.

### DETAILED DESCRIPTION

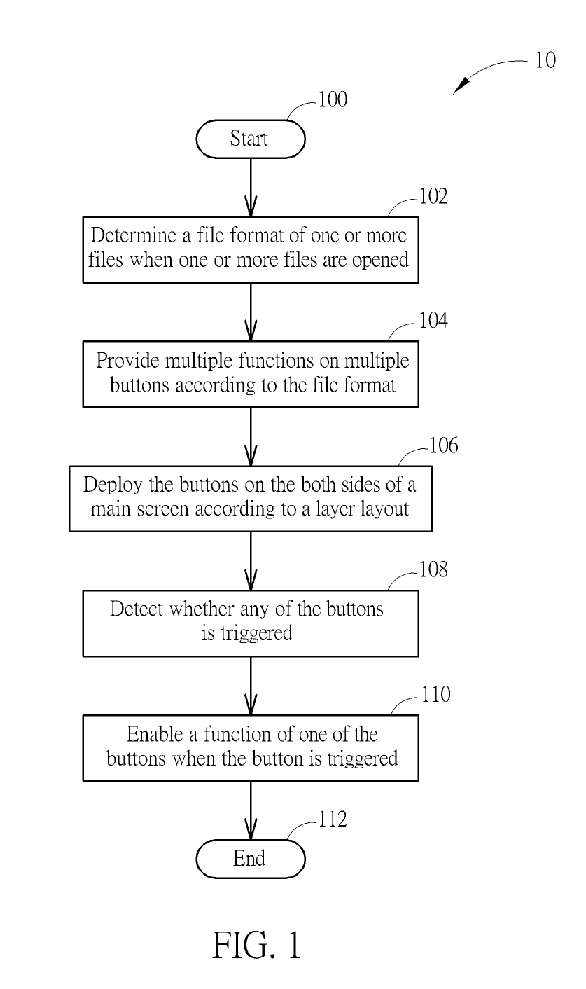

Please refer to FIG. 1, which is a schematic diagram of a process 10 according to an embodiment of the present invention. The process 10 is utilized for interacting with a large display device, and may be realized by software or application. The process 10 includes the following steps:

Step 100: Start.

Step 102: Determine a file format of one or more files when one or more files are opened.

Step 104: Provide multiple functions on multiple buttons according to the file format.

Step 106: Deploy the buttons on the both sides of a main screen according to a layer layout.

Step 108: Detect whether any of the buttons is triggered.

Step 110: Enable a function of one of the buttons when the button is triggered.

Step 112: End.

According to the process 10, an embodiment of the present invention may provide different functions according to different file formats. Each function may control one or more files. The file formats may include an audio file format (e.g. mp3 file), a video file format (e.g. mpeg file), an image file format (e.g. jpg file) or a briefing format (e.g. ppt file), which is not limited herein. For example, when a file with the audio file format is opened, an embodiment of the present invention may provide frequently used functions for the audio file format such as Play, Pause, Next or Previous. When a file with the video file format is opened, an embodiment of the present invention may provide frequently used functions for the video file format such as Play, Pause, Next or Previous. When a file with the image file format is opened, an embodiment of the present invention may provide frequently used functions for the image file format such as Autoplay, Pause, Next Page or Previous Page. When a file with the briefing format is opened, an embodiment of the present invention may provide frequently used functions for the briefing format such as Previous Page, Next Page, Slide Show or Pointer Options. In order to perform the above functions more easily when the file is opened, each function may correspond to a button, and each button includes a context or an icon indicating the corresponding function. When the file is displayed on the large display, an embodiment of the present invention deploys multiple buttons on the both sides of the main screen from top to bottom according to a layer layout in order to prevent the main screen from being blocked by the other buttons, so that the both sides of the main screen may have the same buttons. When a button is triggered (e.g. a user touches the button), a feedback signal corresponding to the button may be transmitted; hence, the function corresponding to the button may be enabled, which allows the user to further control the opened files.

In brief, the embodiments of the present invention may provide different functions according to different file formats; hence, the operating processes may be simplified, so that the user may not need to remember the positions of scattered buttons, and unnecessary functional buttons may be reduced. Besides, the method of deploying the same buttons on both sides of the main screen can solve the problem that the user needs to search for the icons when standing at different positions. The problem of different dominant hands may also be solved, and the user may operate directly without turning around or taking other actions. In addition, such feature may break through limitations of the environment. For example, if there is an obstacle at the right side of a platform and the obstacle blocks the user, the same buttons on the other side may be utilized for operations. This feature also allows two persons to operate the played file content simultaneously. The layer layout of the buttons also reduces tiredness of the user due to excessively movements of the arm.

In addition, the process 10 may include other steps such as executing an identification technique and automatically adjusting the positions of the buttons. The identification technique may include a projecting touch identification technique, a touch identification technique, an image identification technique or any identification technique that can be utilized for determining whether a button is triggered; those techniques can be utilized in the embodiments of the present invention. The interactive application unit can therefore determine whether a button is triggered by executing an identification technique. Besides, the interactive application unit may detect the height of a user, and automatically adjust the height of the buttons to be adaptive to the user's height. Therefore, when operating the interactive application unit on the large display device, the user may easily touch each button. The body of the user will not block the buttons, and frequent movement of the body is unnecessary.

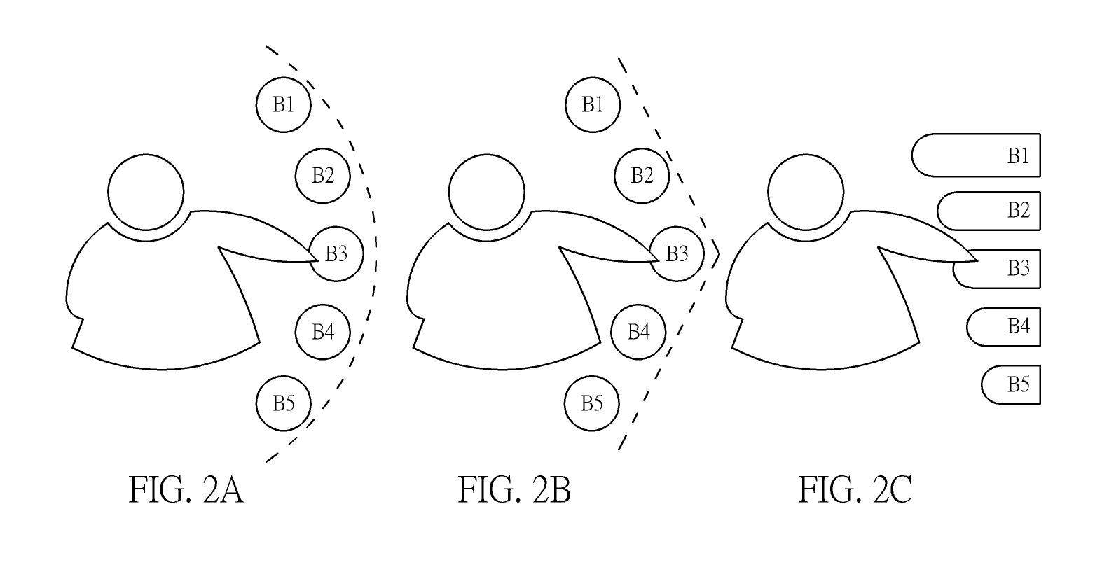

Please refer to FIGS. 2A, 2B and 2C, which are schematic diagrams of a layer layout of a plurality of buttons according to embodiments of the present invention. In FIG. 2A, buttons B1, B2, B5 are deployed on the both sides of the main screen in an arc layout from top to bottom according to a curve generated by movements of the user's arm. In FIG. 2B, buttons B1, B2, B5 are also deployed around the user from top to bottom according to the movements of the user's arm. In FIG. 2C, buttons B1, B2, B5 are deployed on the both sides of the main screen in a ladder-shaped layout from top to bottom.

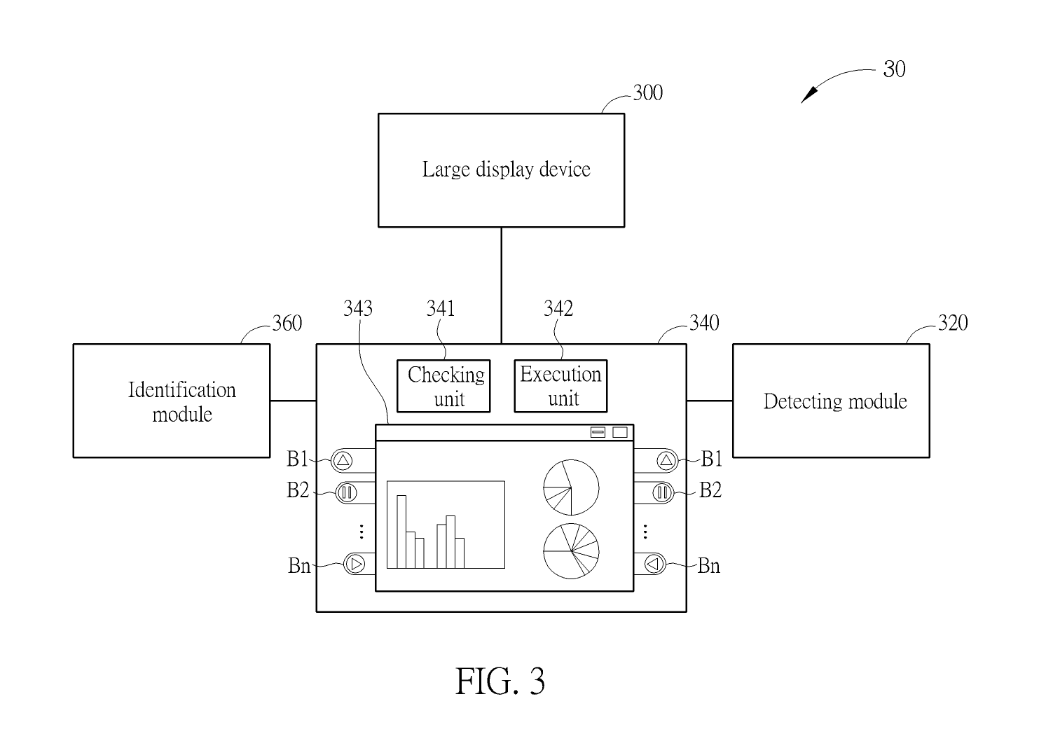

Please refer to FIG. 3, which is a schematic diagram of an interactive system 30 according to an embodiment of the present invention. The interactive system 30 includes a large display device 300, a detecting module 320, an interactive application unit 340 and an identification module 360. The large display device 300 is utilized for displaying a file content of one or more files. The large display device 300 may be a large touch screen, a large screen and a projector, etc. The detecting module 320, coupled to the large display device 300, is utilized for detecting the height of a user. The detecting module 320 may be implemented by photographic devices (e.g. cameras). The interactive application unit 340, coupled to the large display device 300, is utilized for opening one or more files. The interactive application unit 340 includes a checking unit 341, an execution unit 342 and an interactive interface 343. The interactive application unit 340 may be software of a file checker, and the interactive interface 343 may be a graphic user interface. The interactive application unit 340 is displayed on the large display device 300 via the interactive interface 343. The checking unit 341 is utilized for determining a file format when the file is opened. The interactive interface 343, which includes buttons B1, B2, Bn, is utilized for providing a plurality of functions on the buttons B1, B2, Bn according to the file format or the file content, wherein each button has a context or an icon corresponding to one of the functions. The buttons B1, B2, Bn may be deployed on the both sides of the main screen according to a layer layout. The main screen displays a file content of a file currently played. The execution unit 342 is utilized for executing the functions, wherein each function is utilized for controlling one or more files. Please note that, the large display device 300, the detecting module 320 and the identification module 360 may be integrated in a touch display device or realized in different devices, respectively.

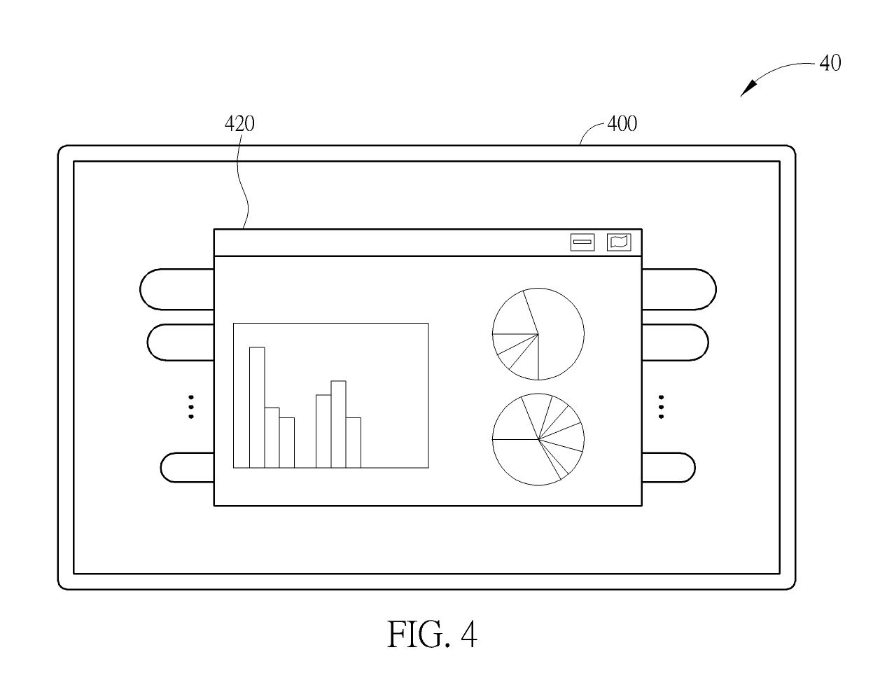

The specific implementations of the interactive system are illustrated in FIGS. 4-9. FIG. 4 is a schematic diagram of an interactive system 40 according to an embodiment of the present invention. The interactive system 40 includes a large touch screen 400 and an interactive application unit 420. The large touch screen 400 is utilized for realizing the large display device 300, the detecting module 320 and the identification module 360 of the interactive system 30. The interactive application unit 420 may be installed in an operating system of the large touch screen 400. When a user utilizes the interactive application unit 420 to open a file, the interactive application unit 420 may determine the file format of the file and provide multiple functions on multiple buttons according to the file format. When the user touches a button of the interactive application unit 420, the large touch screen 400 may execute the touch identification technique and determine that the button of the interactive application unit 420 is triggered. The interactive application unit 420 then enables the function of the button, in order to control the file. The touch identification technique may be resistive, capacitive or light sensing, etc.

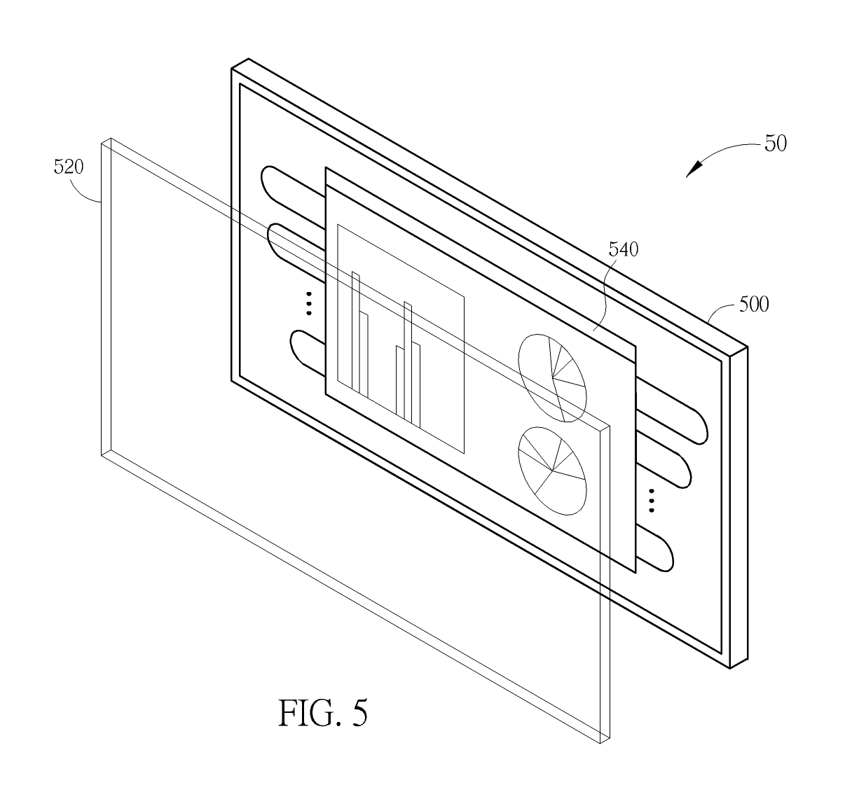

FIG. 5 is a schematic diagram of an interactive system 50 according to an embodiment of the present invention. The interactive system 50 includes a large display device 500, an out-cell touch screen 520 and an interactive application unit 540. The interactive application unit 540 is installed in an operating system of the large display device 500. Since the large display device 500 does not have touch functions, the out-cell touch screen 520 is required. When a user utilizes the interactive application unit 540 to open a file, the interactive application unit 540 may determine the file format of the file and provide multiple functions on multiple buttons according to the file format. When the user touches a button of the interactive application unit 540, the out-cell touch screen 520 may execute the touch identification technique and determine that the button of the interactive application unit 540 is triggered. The interactive application unit 540 then enables the function of the button, in order to control the file. The touch identification technique may be resistive, capacitive or light sensing, etc.

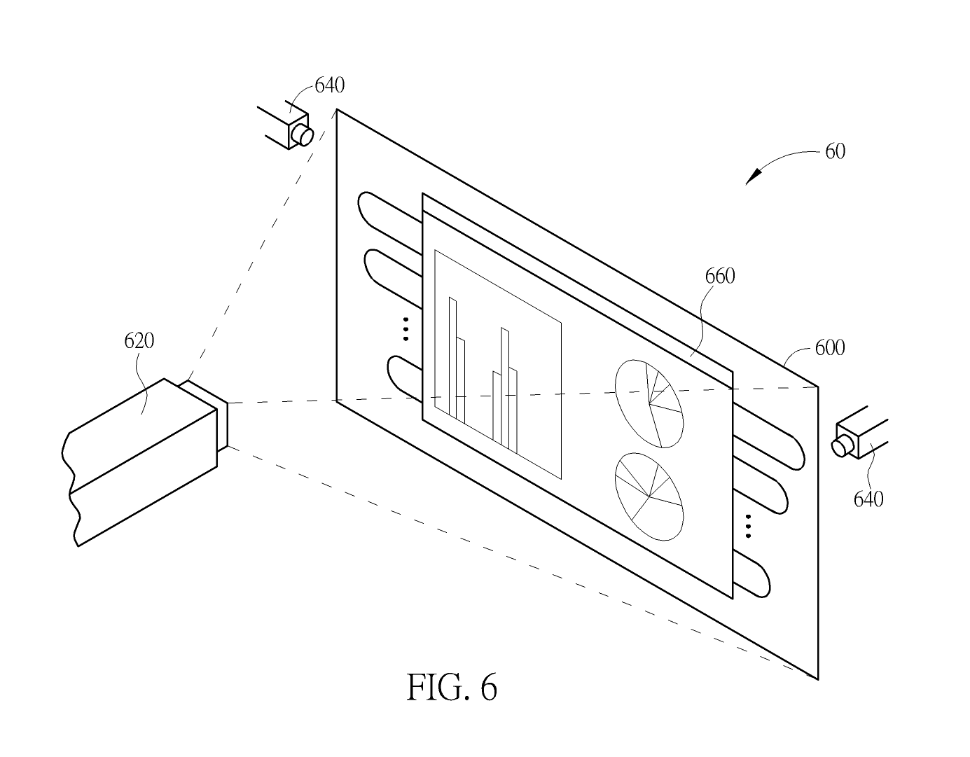

FIG. 6 is a schematic diagram of an interactive system 60 according to an embodiment of the present invention. The interactive system 60 includes a screen wall 600, a projector 620, a camera module 640 and an interactive application unit 660. The interactive application unit 660 is installed in the projector 620. When a user utilizes the interactive application unit 660 to open a file, the interactive application unit 660 may determine the file format of the file and provide multiple functions on multiple buttons according to the file format. When the user touches a button of the interactive application unit 660, the camera module 640 may execute the image identification technique or projecting touch identification technique, and determine that the button of the interactive application unit 660 is triggered. The interactive application unit 660 then enables the function of the button, in order to control the file.

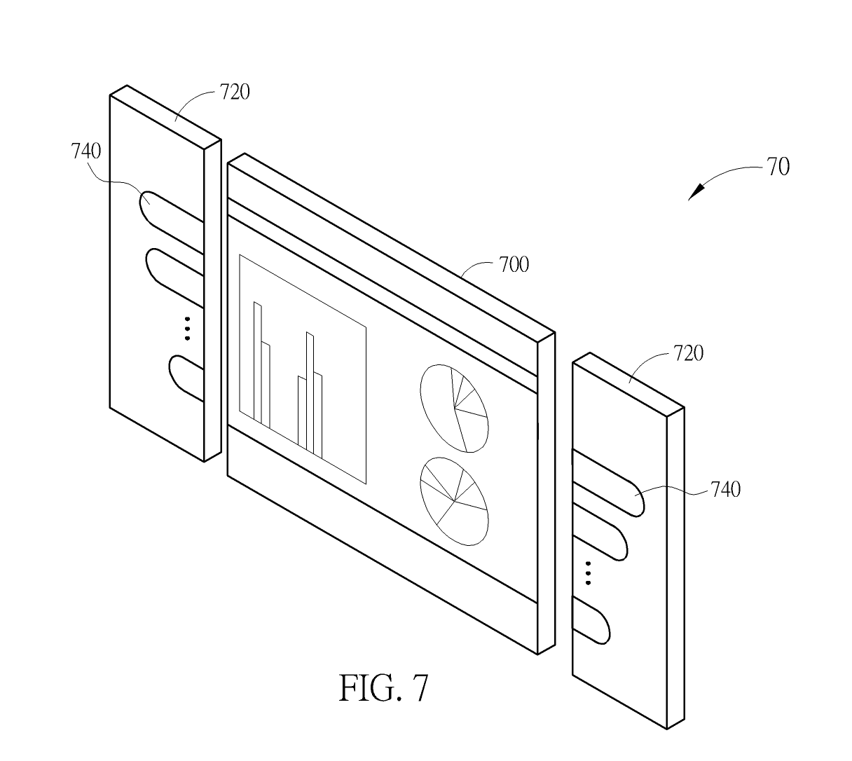

FIG. 7 is a schematic diagram of an interactive system 70 according to an embodiment of the present invention. The interactive system 70 includes a large display device 700, two touch screens 720 and interactive application units 740. The interactive application units 740 are installed in an operating system of the large display device 700. The touch screens 720 are utilized as extended screens of the large display device 700, which prevents the display image and ratio from being reduced. When a user utilizes the interactive application units 740 to open a file, the interactive application units 740 may determine the file format of the file and provide multiple functions on multiple buttons according to the file format. When the user touches a button of the interactive application units 740, the touch screens 720 may execute the touch identification technique and determine that the button of the interactive application units 740 is triggered. The interactive application units 740 then enable the function of the button, in order to control the file. The touch identification technique may be resistive, capacitive or light sensing, etc. Please note that the large display device 700 may be connected to the touch screens 720 in a wired or wireless manner to transmit display/control information to each other.

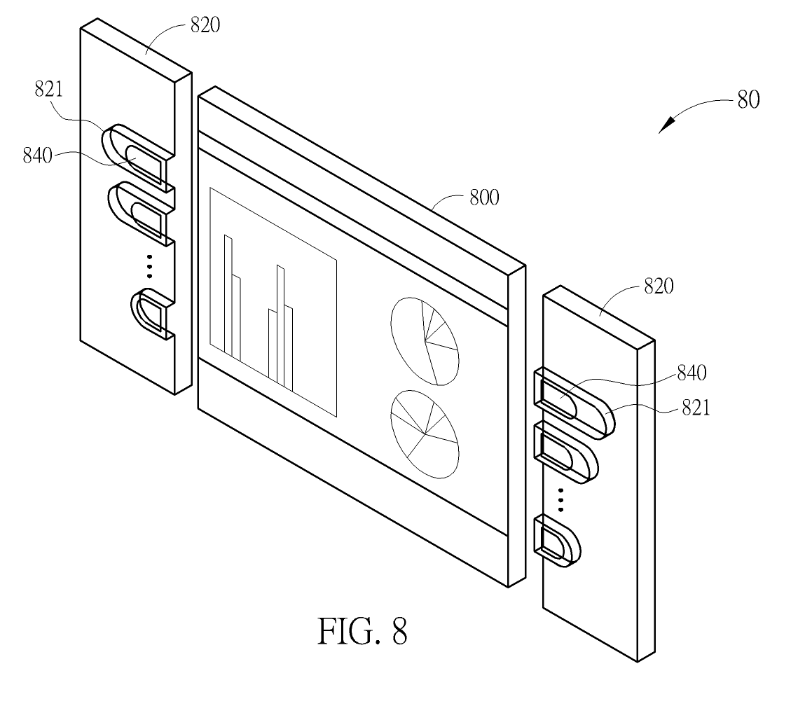

FIG. 8 is a schematic diagram of an interactive system 80 according to an embodiment of the present invention. The interactive system 80 includes a large display device 800, two screens 820 and interactive application units 840. The interactive application units 840 are installed in an operating system of the large display device 800. The screens 820 include multiple transparent physical buttons 821. When a user utilizes the interactive application units 840 to open a file, the interactive application units 840 may determine the file format of the file and display multiple functions on the transparent physical buttons 821 according to the file format, so that the user may determine the button more directly. When the user directly touches the transparent physical buttons 821 on the screens 820, the function of the interactive application units 840 displayed on the transparent physical buttons 821 is enabled, in order to control the file. Please note that the screens 820 may or may not have the touch functions. When the screens 820 have the touch functions, the transparent physical buttons 821 may not need any mechanic operation capability, and may only provide a feedback signal corresponding to a press on the button such as a capacitive touch screen. When the screens 820 has no touch functions, the transparent physical buttons 821 may only display a graphic user interface of the interactive buttons, and the main identification technique is applied by the mechanic operation capability of the transparent physical buttons 821.

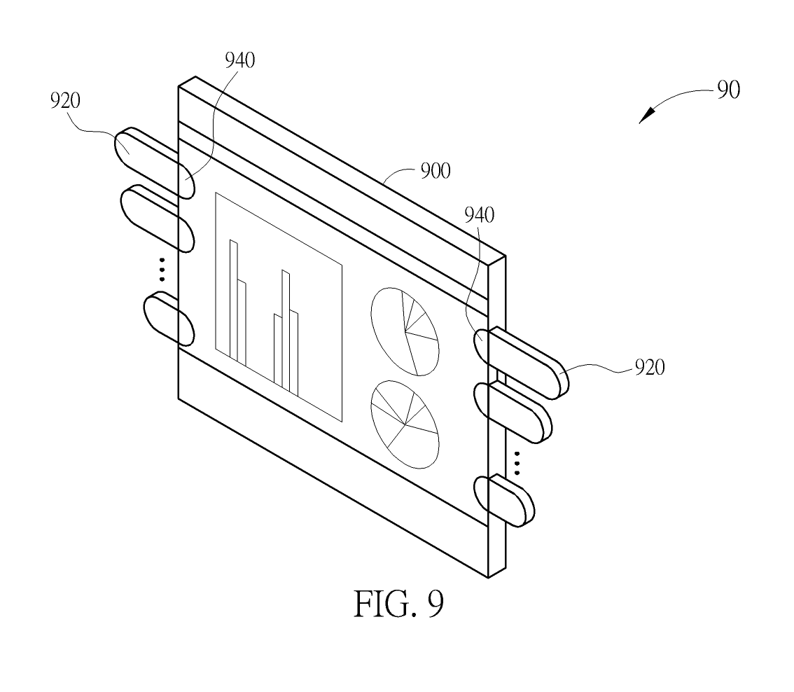

FIG. 9 is a schematic diagram of an interactive system 90 according to an embodiment of the present invention. The interactive system 90 includes a large display device 900, multiple physical buttons 920 and interactive application units 940. The interactive application units 940 are installed in an operating system of the large screen 900. The interactive application units 940 provide contexts corresponding to the physical buttons 920, where each context is utilized for indicating the functions provided by the physical buttons 920. When a user utilizes the interactive application units 940 to open a file, the interactive application units 940 may determine the file format of the file and provide a plurality of functions on the physical buttons 920 according to the file format. When user directly touches the physical buttons 920, the functions of the buttons are enabled, in order to control the file.

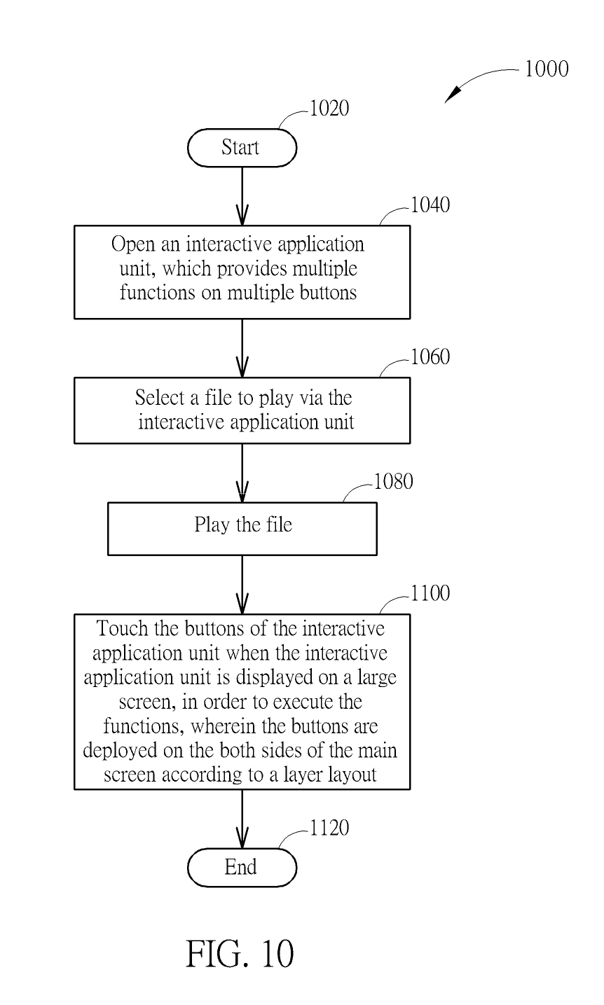

Please refer to FIG. 10, which is a schematic diagram of an operating process 1000 of an interactive application unit according to an embodiment of the present invention. A user may execute the interactive application unit according to the operating process 1000. The operating process 1000 includes the following steps:

Step 1020: Start.

Step 1040: Open an interactive application unit, which provides multiple functions on multiple buttons.

Step 1060: Select a file to play via the interactive application unit.

Step 1080: Play the file.

Step 1100: Touch the buttons of the interactive application unit when the interactive application unit is displayed on a large screen, in order to execute the functions, wherein the buttons are deployed on the both sides of the main screen according to a layer layout.

Step 1120: End.

According to the operating process 1000, since the buttons of the interactive application unit are deployed on the both sides of the main screen, the user may not block the displayed content when operating, and the required moving distance for operations may also be reduced, which further reduces the tiredness due to the operations. Besides, the method of deploying the same buttons on the both sides of the main screen can solve the problem that the user needs to search for the icons when standing at different positions. The problem of different dominant hands may also be solved, and the user may operate on the icons directly without turning around or taking other actions. In addition, such feature may break through limitations of the environment. For example, if there is an obstacle at the right side of a platform and the obstacle blocks the user, the buttons on the other side may be utilized for operations. This feature also allows two persons to perform the presentation simultaneously. The layer layout of the plurality of buttons also reduces tiredness of the user due to excessively movements of the arm.

To sum up, the embodiments of the present invention can solve the problems generated from interaction with the large display devices. The interactive application unit aggregates common used functions to the same area and separates the display area and the operation area, which allows the user to operate more easily. The audience may also watch the information on the display without being affected. In addition, the interactive application unit may change the functions of the button according to the opened file, in order to achieve humanized, simplified and rapid interaction.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of interacting with a large display device comprising:
determining a file format of at least one file when the at least one file is opened;
providing a plurality of functions on a plurality of buttons according to the file format, wherein each of the plurality of functions controls the at least one file;
deploying the plurality of buttons on both sides of a main screen according to a layer layout, wherein each of the plurality of buttons includes a context or an icon corresponding to one of the plurality of functions;
determining whether any of the plurality of buttons is triggered; and
enabling a function of one of the plurality of buttons when the button is triggered.

2. The method of claim 1, further comprising executing an identification technique in order to determine whether any of the plurality of buttons is triggered.

3. The method of claim 2, further comprising:
detecting a height of a user; and
automatically adjusting positions of the plurality of buttons according to the height of the user.

4. The method of claim 2, wherein the identification technique is a projection touch identification technique, a touch identification technique or an image identification technique.

5. The method of claim 1, further comprising:
detecting a height of a user; and
automatically adjusting positions of the plurality of buttons according to the height of the user.

6. The method of claim 1, wherein the layer layout comprises an arc layout, a surrounding layout or a ladder-shaped layout.

7. The method of claim 1, wherein the file format comprises an audio file format, a video file format, an image file format or a briefing format.

8. An interactive system, comprising:
a large display device, for displaying content of a file; and
an interactive application unit, for opening the file, the interactive application unit comprising:
a checking unit, for determining a file format of the file when the file is opened;
a graphic user interface, for providing a plurality of functions according to the file format, the graphic user interface comprising a plurality of buttons, which are deployed on both sides of a main screen according to a layer layout, wherein each of the plurality of buttons includes a context or an icon corresponding to one of the plurality of functions; and
an execution unit, for enabling a function of one of the plurality of buttons when the button is triggered;
wherein each of the plurality of functions controls the at least one file.

9. The interactive system of claim 8, further comprising a detecting module, for detecting a height of a user.

10. The interactive system of claim 9, further comprising an identification module, for executing an identification technique in order to determine whether any of the plurality of buttons is triggered.

11. The interactive system of claim 10, wherein the identification module utilizes a projection touch identification technique.

12. The interactive system of claim 8, further comprising an identification module, for executing an identification technique in order to determine whether any of the plurality of buttons is triggered.

13. The interactive system of claim 12, wherein the identification module utilizes a projection touch identification technique, a touch identification technique and an image identification technique.

14. The interactive system of claim 8, wherein the layer layout comprises an arc layout, a surrounding layout or a ladder-shaped layout.

15. The interactive system of claim 8, wherein the file format comprises an audio file format, a video file format, an image file format or a briefing format.
